(19) United States
(12) Patent Application Publication
(10) Pub. No.: US 2025/0337192 A1
(43) Pub. Date: Oct. 30, 2025

(54) RETENTION SYSTEM FOR THREADED CONNECTORS

(71) Applicant: Raythen Company, Tewksbury, MA (US)

(72) Inventor: Bradley O. Hansen, Vail, AZ (US)

(21) Appl. No.: 18/647,761

(22) Filed: Apr. 26, 2024

(51) Int. Cl. H01R 13/622

(52) U.S. Cl. CPC H01R 13/622

(57) ABSTRACT

A retention system for a threaded fastener is contemplated. The retention system optionally includes a threaded housing having one or more engagement recesses extending through a portion of the housing wall. A threaded hub including a plurality of teeth and a trough between each tooth of the plurality of teeth is coupled with the threaded housing. A vise anchor, (e.g., a clip, clasp, clamp, or other similar fastener) includes two or more jaws interconnected by a bridge. Each jaw includes an engagement portion where the engagement portion is sized and shaped to extend through the one or more engagement recesses and be received within the trough. Each jaw is formed to maintain retention of the threaded hub received within the housing.

### BACKGROUND

Electrical connections are foundational components in electrical and electronic systems, providing the pathways for electrical current to flow between different parts of a circuit or between different devices. The reliability and performance of these connections assist in the overall functionality of the system.

Some electrical connections are permanent, and others are reversible. For example, soldered or crimped connections are permanent connections achieved by forming strong mechanical connections where separation of the components could damage the electrical system. In other examples, screw terminals, plug and socket connections, or wire nuts are reversable connection such that the components are joined and separated without damage to the electrical system and according to the purpose.

Reversible electrical connections are found in many different applications and subject to a wide range of environmental conditions. For example, electrical systems with reversible electrical connections are subjected to environments where the reversable connections disengagement, disconnection or the like is a possibility. In some examples, the environmental conditions include those where the electrical system is subjected to vibrations, shocks, unintentional movement or the like. In such situations, over time, the connection loosens such that there is an intermittent or total loss of communication between the connected parts.

### SUMMARY

At times two components of an electrical system are joined to form an electrical pathway. For example, maintaining torque between threaded electrical connectors assists in preventing a loss of electrical performance over time. In some systems, torque, vibrations, or movement of the assembly loosens the threaded connector leading to a loss of ground or degradation in signal retention.

Threaded engagements are used in a multitude of electrical system applications because of the reliability of maintaining an electrical connection between two components. For example, threaded connectors, such as a type-N connector or SubMiniature version A (SMA), have threads that provide a secure mechanical connection and ensure good electrical contact. In other examples, radio frequency (RF) connectors included threaded connections to maintain shielding and minimize signal loss. In yet another example, coaxial cables use a threaded connection to transmit a high frequency electrical signal with low to minimal loss from one connector to another.

Threaded fasteners are joined together by rotating one component relative to another component having a mating threaded engagement. Over time, the threaded connection can be rotated in a direction reversed to the mating direction. The reversed rotation, intentional or unintentional, can loosen the connection between the two components resulting in a poor connection or disengagement of the electrical system.

In environments where the electrical system is subjected to movement, it is possible for threaded electrical connectors to lose connectivity. In some situations, a poor electrical connection or even complete disconnection is detrimental to a larger system, apparatus or the like.

In examples, additional components, are added to the electrical system to assist in maintaining a connection between mating components. For example, adhesives are applied to the electrical connectors to maintain an electrical connection. However, adhesives can migrate during installation and affect the performance of the electrical system.

In an example of the present disclosure, a retention system for a threaded fastener is contemplated. The retention system optionally includes a threaded housing having one or more engagement recesses extending through a portion of the housing wall. A threaded hub including a plurality of teeth and a trough between each tooth of the plurality of teeth is coupled with the threaded housing. A vise anchor, (e.g., a clip, clasp, clamp, or other similar fastener) includes two or more jaws interconnected by a bridge. Each jaw includes an engagement portion where the engagement portion is sized and shaped to extend through the one or more engagement recesses and be received within the trough. Each jaw is formed to maintain retention of the threaded hub received within the housing.

### BRIEF DESCRIPTION OF THE DRAWINGS

FIG. 1 illustrates a retention system for an electrical connection according to at least one example of the present disclosure.

FIG. 2 illustrate a component view of retention system for an electrical connection according to at least one example of the present disclosure.

FIG. 3A illustrates a vise anchor and threaded housing according to at least one example of the present disclosure.

FIG. 3B illustrates a threaded hub according to at least one example of the present disclosure.

FIGS. 4A and 4B illustrate a retention system for an electrical connection according to at least one example of the present disclosure.

FIG. 5 illustrates a cross section of a retention system for an electrical connection according to at least on example of the present disclosure.

### DETAILED DESCRIPTION

In some examples, electrical systems with two or more components are joined together with features such as soldered or crimped connections as permanent connections forming strong mechanical connections where separation of the components would damage the electrical system. In other examples, screw terminals, plug and socket connections or wire nuts are connections that are reversible such that the electrical connection is not damaged when the connections are separated. In some examples, threaded components (e.g., screw terminals) are used to securely coupled the components.

Threaded components are used to bring electrical components together to form an electrical system. For example, coaxial cables are electrical cables that able to carry and deliver high frequency, multi-megahertz electrical signals. Coaxial cables include an inner conductor that is surrounded by conducting shield. The conductor is separated from the shield with a dielectric material.

Connectors are optionally designed to withstand mechanical stresses of connection and disconnection, as well as environmental factors like temperature and humidity. Some connectors include radio frequency connectors, audio/visual connectors, data connectors, circular connectors, coaxial connectors, fiber optic connectors. Some examples of connectors in electrical systems include a radio frequency (RF) connectors that used in connection with coaxial cables. RF connectors are a broad category of connectors designed to work at radio frequencies in the multi-megahertz range. In some examples, they are used to connect coaxial cables and maintain the shielding that coaxial design offers. There are many types of RF connectors, including N Type, SMA, BNC, TNC, and more, each with its own specific applications and frequency ranges.

N Type connectors are medium-sized, threaded RF connectors capable of carrying signals up to 11 GHz (some precision versions go up to 18 GHz). SubMiniature version A (SMA) connectors are smaller than N Type and provide high-frequency performance up to 18 GHz, with some precision models designed to work up to 26.5 GHz.

These connectors are examples of components in any system that transmits or receives radio frequencies. RF connectors are used in a wide array of applications, from consumer electronics to specialized military and aerospace systems. For example, N Type connectors are suitable for outdoor applications and that handle high power transmission. N type connectors are optionally used for base stations, antennas, and satellite systems. Because of the size or profile, SMA connectors are optionally used in microwave systems, hand-held radio and mobile telephone antennas, and other applications where space is limited.

In some examples, the connectors are threaded connectors. For instance, opposing connectors are joined with a mating threaded engagement such that one connector is twisted on to an opposing mating connector. During repeated connection and disconnection, repeated twisting causes wear to the connection and loosens the connection. In other examples, repeated vibrations, stresses or mechanical forces reverses the twisting and the threaded connection becomes loose and, at times, disengages one connector from the opposing.

At times, a specific amount of torque is applied to a threaded connection, ensuring the connectors are properly engaged for optimum performance of the electrical system. Threaded connectors have one locking features, the torque, to remain fastened. In such situations, maintaining the specific amount of torque becomes difficult due to the environmental conditions the electrical system is subjected to. For example, in high-speed applications (e.g., aviation, automotive, maritime, or the like) vibrations are likely to occur that loosen the threaded connection. In other examples, movement of a system or repeated interactions with the system causes forces to be applied to the electrical system that loosens or disengages the electrical connectors from their optimum, or desired, torque.

Some examples of retention systems include a chassis mount, mounting feature nut, bolt, washer, or 136 to distribute a load or application of force applied to the electrical coupling. Minimizing the load can assist in maintaining a connection, for example a threaded connection, between a threaded hub and a threaded housing. In other examples, the washer a is applied to the electrical coupling to minimize the electrical connection from becoming loose or disengaged when coupled with the threaded housing.

The present inventors have recognized a retention system that enhances the stability and reliability of threaded electrical connections. For example, the present inventors contemplate a retention system for a threaded fastener, such as a secondary retention system. In an example, the secondary retention system works in conjunction with the threaded retention system of a threaded fastener. The threaded fastener is an example of an electrical connection.

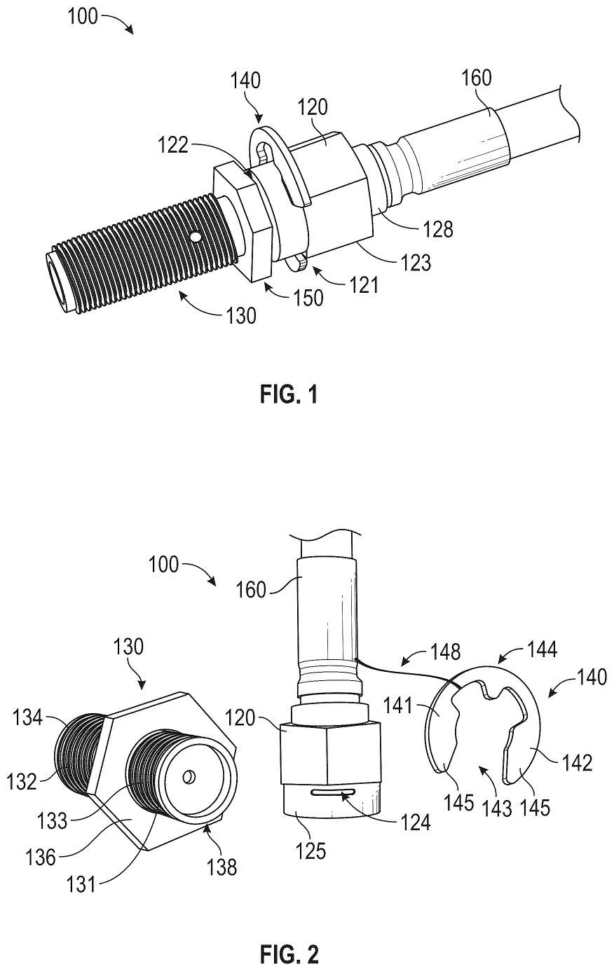

Illustrated in FIG. 1 is an example of a retention system 100 for an electrical connection 150. In some examples, the electrical connection 150 includes a threaded housing 120 that mates with a threaded hub 130. The threaded housing 120 includes, for example, a junction portion 128. The junction portion 128 is optionally coupled (e.g., connected, bonded, joined or the like) with an electrical cable 160. The electrical cable 160 is, for example, a coaxial cable.

At an opposing end of the threaded housing 120 to the junction portion 128 is a housing opening 122. The housing opening 122 is formed to receive the threaded hub 130. In examples, the housing opening 122 is designed to be a similar shape or a complementary shape as the threaded hub 130. In for instance, the threaded hub 130 has a complementary thread to the thread of the threaded housing 120.

The retention system 100 includes, for example a vise anchor 140. The vise anchor 140 is an example of a component that is designed to apply a force to the electrical connection 150 to maintain the placement of the threaded housing 120 relative to the threaded hub 130. In some examples, the vise anchor 140 is designed to couple with the threaded housing 120 and the threaded hub 130.

In examples, the vise anchor 140 is a retention component that holds (e.g., clamps, clasp, retains, grips, maintains) the threaded housing 120 in place. In an example, the vise anchor 140 firmly and statically holds the threaded housing 120 in place when the threaded housing 120 is coupled with the threaded hub 130. The vise anchor 140, in an example, includes elements, such as two or more jaws 141, 142 where the two or more jaws 141, 142 cooperate to hold (e.g., clamps, clasp, retains, grips, maintains) the threaded housing 120 in place. For example, the vise anchor 140 uses the first jaw 141 and the second jaw 142 to hold (e.g., clamps, clasp, retains, grips, maintains) the threaded housing 120 in engagement with the threaded hub 130.

FIG. 2 is an illustration of an example of the components of the retention system 100. Illustrated in FIG. 2 is an example of the threaded hub 130, threaded housing 120 and the vise anchor 140. The components of the retention system 100 are in an uncoupled configuration. Illustrated in FIG. 2, the threaded hub 130 is a component of a coaxial connection system. The retention system discussed herein is applicable in any of a number of electrical or mechanical systems where threaded connections are coupled and benefit from application of a retention force different from torque.

As illustrated in the example of FIG. 2, the threaded hub 130 is a threaded shaft 132. The threaded hub 130 optionally is an axially extending connector with a continuously extending thread 134 around a perimeter surface of the threaded hub 130. In an example, the thread 134 extends from a connecting portion 138 towards a distal portion of the threaded hub 130. In other examples, the thread 134 is not continuous and there is spacing, or gaps, formed between areas of threading. The thread 134 includes a plurality of teeth 133 protruding away from the perimeter of the threaded hub 130. Between each of the plurality of teeth 133 is a trough 131 as a concave feature of the thread 134 between at least two adjacent teeth.

In an example, the threaded hub 130 has a complementary fit, such as a complementary thread, with the threaded housing 120. For example, the threaded hub 130 is rotatably received within the threaded housing 120. The threaded hub 130 is optionally rotated according to a specified amount of torque to complete an electrical connection between the threaded hub 130 and the threaded housing 120.

The threaded housing 120, for example, includes one or more engagement recess 124. The one or more engagement recess 124 is an example of an opening extending at least partially through the threaded housing 120. The one or more engagement recess 124, for example, has a form that receives at least a portion of the vise anchor 140. For example, the one or more engagement recess 124 is an opening extending through a wall 126 of the threaded housing 120.

In an example, the one or more engagement recess 124 spans at least a portion of the wall 126 of the threaded housing 120. For instance, the one or more engagement recess 124 arcuately spans an outer surface of the threaded housing 120 such that the one or more engagement recess 124 follows a curvature 125 of the threaded housing 120.

Also illustrated in FIG. 2 is the vise anchor 140 decoupled from the threaded housing 120 and the threaded hub 130. In examples, the vise anchor 140 is a clip, clasp, clamp, binder or a similar fastener which provide, optionally, a secondary retention system to supplement the primary threaded connection. The vise anchor 140 is formed to statically hold the threaded housing 120 relative to the threaded hub 130, as a secondary retention component.

In examples, the vise anchor 140 is connected with the threaded housing 120 or the electrical cable 160 with a tether 148. In an example the tether 148 is a cord, cable, wire, or the like. The tether 148, for example, assists in retaining the vise anchor 140 with the threaded housing 120 to minimize the likelihood that the vise anchor 140 is lost or misplaced.

The vise anchor 140 has a form, for example, that corresponds to the threaded housing 120. For instance, the vice anchor 140 is formed to be similar to the outer profile of the associated threaded housing 120. The vise anchor 140, for example, includes the two or more jaws 141, 142 interconnected with a bridge 144. For example, the first jaw 141 and the second jaw 142 are spaced with a gap 143 between. The bridge 144, for example is an arcuate bridge, interconnects for example a nonengaging portion of the vise anchor 140, or the portion of the vise anchor 140 that does not engage with the one or more engagement recess 124.

Extending into the gap 143 from the bridge 144 is a limiting protrusion 147. The limiting protrusion 147 is an example of an extension from the bridge 144 that comes into contact with the threaded housing 120 when the vise anchor 140 engages with the threaded housing 120. For example, the limiting protrusion 147 restricts the amount the one or more engagement portion 145 enters into the one or more engagement recess 124.

The vise anchor 140 includes one or more engagement portion 145 at an end portion of the first jaw 141 or second jaw 142. The engagement portions 145 are optionally located on either side of the gap 143 between the first jaw 141 and the second jaw 142. The one or more engagement portion 145 is formed to be received, fit or extend through the one or more engagement recess 124.

The engagement portion 145 is formed to hold, retain, grip or the like the threaded housing 120 relative to the threaded hub 130. For example, the one or more engagement portion 145 extends through the one or more engagement recess 124 and contacts the threaded hub 130. For example, the engagement portion 145 is formed to be received in the trough 131 of the threaded hub 130.

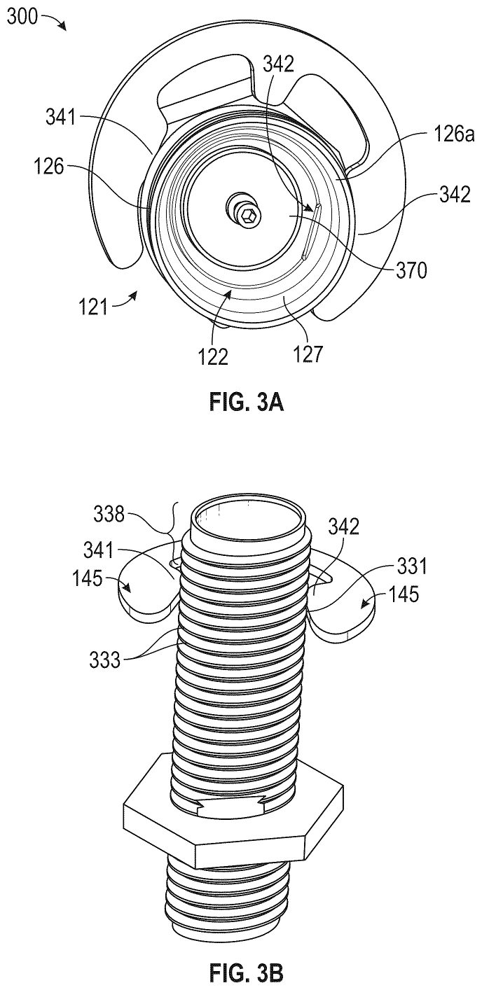

FIG. 3A illustrates an example of a connection apparatus 300 for the electrical connection 150. The connection apparatus 300 includes, for example, the threaded housing 120. The threaded housing 120 is an example of one connection of an electrical connection. The threaded housing 120 includes, as discussed related to FIG. 1, a junction portion that is coupled with, for example, a cable or other support structure. On an opposing portion of the threaded housing 120 there is the housing opening 122. For example, the threaded housing 120 has a first end portion 121 and a second end portion 123 (illustrated in FIG. 1). In examples, the threaded housing 120 includes a wall 126. The wall 126, for example, defines the housing opening 122. The housing opening 122 is sized and shaped to receive a threaded hub 130 (as illustrated in FIGS. 1 and 2).

A thread 127 extends within an interior wall 126a of the threaded housing 120. In an example, the thread 127 is a complementary thread to a thread of the threaded hub 130. For instance, the thread 127 is a continuously extending thread that provides an engagement with the threaded hub 130. In other examples, the thread 127 is not a continuous thread, but instead includes one or more gaps or spaces within the thread. The thread 127 couples the threaded housing 120 with, for example, the threaded hub 130 to provide an electrical connection 370. As illustrated in FIGS. 3A and 3B, the threaded housing 120 is an example of one connector of a coaxial cable.

To maintain a reinforced connection between electrical connectors, the vise anchor 140 is optionally coupled with the threaded housing 120. In examples, the vise anchor 140 extends around the threaded housing 120 with the two or more jaws 141, 142 positioned on approximately opposing sides of the threaded housing 120. In examples, the first jaw 141 and the second jaw 142 are placed at first and second spaced positions along the threaded housing 120. In the example illustrated in FIG. 3A, the one or more engagement recess 124 extends through the threaded housing wall 126. With the one or more engagement recess 124 extending through the threaded housing wall 126, the at least one of the one or more engagement portion 145 is able to correspondingly extend through the one or more engagement recess 124 in the threaded housing 120. For example, the one or more engagement recess 124 extends through the wall 126 proximate to the first end portion 121 of the threaded housing 120. The one or more engagement recess 124 is, optionally, positioned on any portion of the threaded housing 120 that corresponds to a placement of the threaded hub 130, when the threaded hub 130 is coupled with the threaded housing 120.

The vise anchor 140 includes for example a first lobe 341 and a second lobe 342 as part of the one or more engagement portion 145. In an example, the first lobe 341 and the second lobe 342 are distal portions of the one or more engagement portions 145. For example, the first lobe 341 and the second lobe 342 are spaced apart with a gap defined between the two. For instance, at least one of the first lobe 341 and the second lobe 342 are formed to extend from one of the first jaw 141 or the second jaw 142 and to be positioned through a corresponding engagement recess 124 and the other of the first lobe 341 or the second lobe 342 is spaced apart to be positioned through a second corresponding engagement recess 124.

Illustrated in FIG. 3B is an example of the vise anchor 140 coupled with the threaded hub 130 without the threaded housing 120. The example of FIG. 3B is illustrative of the first lobe 341 fitting withing a trough 331 between two teeth 333 on the threaded hub 130. In the example illustrated the first lobe 341 and the second lobe 342, each are received, fit, retained within the trough 331 proximate to a connecting end portion 338 of a threaded hub 130 of an electrical connector.

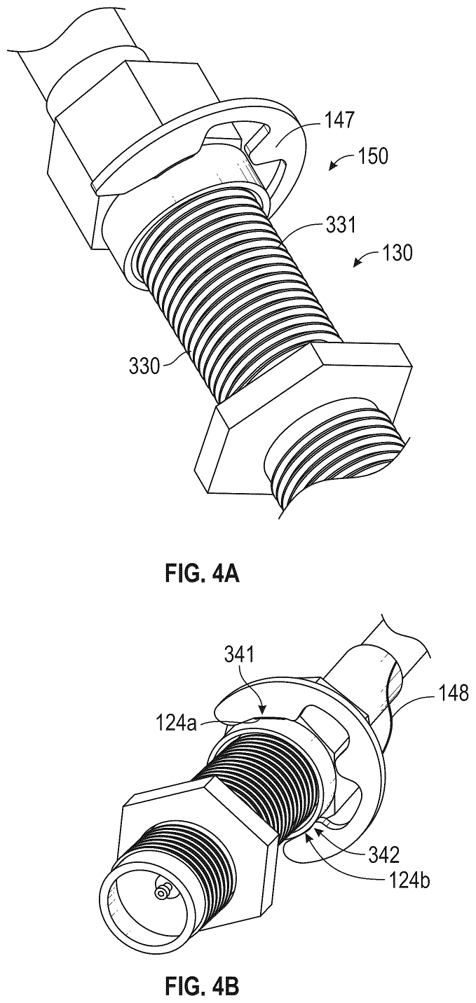

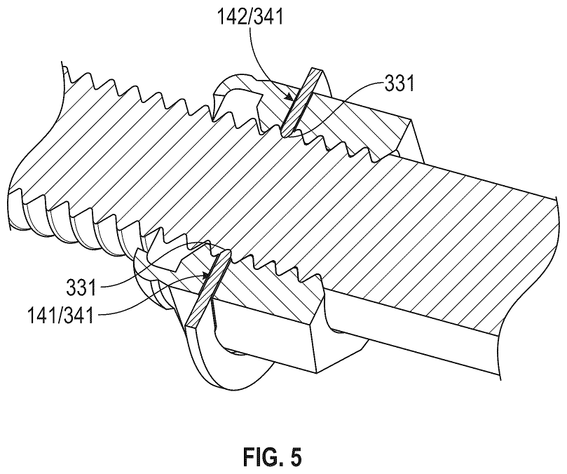

FIG. 4A is an illustration of the retention system 100 for an electrical connection. In an example, the threaded hub 130 is inserted into the threaded housing 120 in a rotation configuration. In examples, the rotation configuration includes a non-specific rotation to ensure the correct torque is applied to the connecting. In some examples, one of the threaded hub 130 or the threaded housing 120 is a male connector and the other is a female connector. In examples, the threaded housing 120 and the threaded hub 130 are components of a radio frequency (RF) connection, N-type connection, SMA, 3.5 connection, 2.92 connection, type F connection, or the like. For example, the threaded hub 130 is inserted into the opening of threaded housing 120 defined by the wall 126 of the threaded housing 120. The interior wall 126 of the threaded housing includes a complementary thread to the threaded hub 130. The threaded hub is rotated with a specified amount of torque to be coupled with the threaded housing 120 and to bring the electrical components in engagement.

When the threaded hub 130 is engaged with the threaded housing 120, one or more engagement recess 124 is correspondingly placed relative to the threads 330 of the threaded hub 130. A trough 331 of the threaded hub 130 is at least substantially aligned with the one or more engagement recess 124. For example, the one or more engagement recess 124 extends through the threaded housing 120 towards the trough 331.

The vise anchor 140 is then, for example, positioned proximate with the one or more engagement recess 124. At least one of the first jaw 141 is positioned to be inserted into one engagement recess 124a of the one or more engagement recess 124. Coupling the vise anchor 140 also, optionally, includes aligning or positioning the second jaw 142 with another engagement recess 124b of the one or more engagement recess 124.

In an example, as illustrated in FIG. 4B, the first jaw 141 is then inserted at least partially through the one engagement recess 124a. In another example, the second jaw 142 is inserted at least partially through another engagement recess 124b of the one or more engagement recess 124. For example, the one or more engagement portion 145 of the first jaw 141 is inserted into the one engagement recess 124a and one or more engagement portion 145 of the second jaw 142 is inserted into another engagement recess 124b. In another example, a first lobe 341 on the one or more engagement portion 145 of the first jaw 141 is inserted through the one engagement recess 124a and the second lobe 342 on the one or more engagement portion 145 of the second jaw 142.

The insertion of the first jaw 141 and the second jaw 142 are arranged and inserted into the one engagement recess 124a and the engagement recess 124b, the limiting protrusion 147, for example, contacts the outer surface of the threaded housing 120. For instance, the limiting protrusion 147 contacts the outer surface of the threaded housing 120 to restrict the first lobe 341 and the second lobe 342 from being inserted too far into a trough 331 of the threaded hub 130. In another example, the limiting protrusion 147 is an optional indicator that the first lobe 341 and the second lobe 342 are not fully inserted.

In examples, as illustrated in FIG. 5, the first jaw 141 is received within at least a portion of the trough 331 and the second jaw 142 is received within at least a portion of the trough 331 spaced from the portion related to the first jaw 141. Optionally, the one or more engagement portion 145 of the first jaw 141 is received into a portion of the trough 331 and one or more engagement portion 145 of the second jaw 142 is received into another portion of the trough 331. In another example, a first lobe 341 on the one or more engagement portion 145 of the first jaw 141 is received in the trough 331 and the second lobe 342 on the one or more engagement portion 145 of the second jaw 142 is received within another, spaced apart, portion of the trough 331.

In another example, the threaded hub 130 is clasped, gripped, held, retained between the first jaw 141 and the second jaw 142. For example, the vise anchor 140 statically retains the threaded hub 130 relative to the threaded housing 120. For example, statically holding the threaded housing 120 relative to the threaded hub 130 with the vise anchor 140 is an example of an anchored configuration of the threaded connection.

When the vise anchor 140 is statically retaining the threaded hub 130 the vise anchor 140 is an example of an addition grounding path for the electrical connection 150. Because of the placement of the vise anchor 140 relative to the threads 134 of the threaded housing 120 or the threads 330 of the threaded hub 130 there is minimal if any impact to the threads 134, 330. Further, because of the placement or position of the vise anchor 140, there is minimal if any adverse impact to the electrical connection 150.

In an example, the retention system 100 is a component of a coaxial cable system or other electrical system with a threaded coupling where the coaxial cable system or the other electrical system is used in an aerospace device such as an aircraft, space craft or other apparatus or device subject to astronautic or aeronautic operations. In another example, the electrical connection implementing the retention system 100 is a component of an automotive system, such as electrical systems of cars, trucks, or the like. In yet another example, the electrical connection implementing the retention system 100 is a component of an aquatic device such as a ship, boat, submarine or the like.

Aspect 1 can include subject matter such as a retention system for an electrical connection, the retention system comprising: a threaded housing having a housing wall, the threaded housing including: an opening, defined by the housing wall, at a first end of the threaded housing; and one or more engagement recesses extending through a portion of the housing wall; a threaded hub including a plurality of teeth and a trough between each tooth of the plurality of teeth; and a vise anchor including: two or more jaws interconnected by a bridge, each jaw including an engagement portion at an end portion; wherein the engagement portion is configured to extend through the one or more engagement recesses; wherein the engagement portion is configured to be received within the trough; wherein in a rotation configuration, the threaded hub is configured to be rotatably received within the threaded housing; wherein in an anchored configuration, the vise anchor is statically coupled with the threaded housing and each jaw is configured to maintain retention of the threaded hub received within the threaded housing.

Aspect 2 can include, or can optionally be combined with the subject matter of Aspect 1, to optionally include the housing wall includes an internal threaded surface configured to mate with the threaded hub.

Aspect 3 can include, or can optionally be combined with the subject matter of one or any combination of Aspects 1 or 2 to optionally include a junction portion on a second side of the threaded housing from the opening; wherein the threaded housing is coupled with an electrical cable at the junction portion.

Aspect 4 can include, or can optionally be combined with the subject matter of one or any combination of Aspects 1 to 3 to optionally include The retention system of clause 1, wherein the threaded hub is a threaded shaft including a complementary thread with the threaded housing.

Aspect 5 can include, or can optionally be combined with the subject matter of one or any combination of Aspects 1 to 4 to optionally include the bridge includes an arcuate profile complementary to perimeter surface of the threaded housing.

Aspect 6 can include, or can optionally be combined with the subject matter of one or any combination of Aspects 1 to 5 to optionally include the retention system is a grounding path.

Aspect 7 can include, or can optionally be combined with the subject matter of one or any combination of Aspects 1 to 6 to optionally include the vise anchor is a clip.

Aspect 8 can include subject matter such as a connection apparatus for a threaded electrical coupling, the connection apparatus comprising: a threaded housing having a first end portion and a second end portion, the threaded housing including: a wall defining an opening at the first end portion; wherein the opening is configured to receive a threaded coupling; one or more engagement recesses extending through the wall proximate to the first end portion; and a junction portion at the second end portion, the junction portion coupled with an electrical cable; and a vise anchor including: two or more jaws, each jaw including an engagement portion at a distal portion, wherein the engagement portion includes a profile configured to be positioned within the one or more engagement recesses.

Aspect 9 can include, or can optionally be combined with the subject matter of one or any combination of Aspect 8 to optionally include the wall includes a threaded interior surface.

Aspect 10 can include, or can optionally be combined with the subject matter of one or any combination of Aspects 8 to 9 to optionally include each engagement portion includes a lobe, the lobe configured to extend through one of the one or more engagement recesses.

Aspect 11 can include, or can optionally be combined with the subject matter of one or any combination of Aspects 8 to 10 to optionally include the vise anchor includes an arcuate bridge extending between each jaw; wherein the arcuate bridge is configured to extend around an perimeter surface of the wall.

Aspect 12 can include, or can optionally be combined with the subject matter of one or any combination of Aspects 8 to 11 to optionally include the threaded housing is configured to mate with an opposing threaded electrical shaft.

Aspect 13 can include, or can optionally be combined with the subject matter of one or any combination of Aspects 8 to 12 to optionally include the engagement portion is configured to fit within a trough of the threaded electrical shaft; wherein in an anchored configuration, the vise anchor is statically coupled with the threaded housing and each jaw is configured to maintain retention of the threaded electrical shaft received within the threaded housing.

Aspect 14 can include, or can optionally be combined with the subject matter of one or any combination of Aspects 8 to 13 to optionally include the threaded housing is a radio frequency (RF) connector.

Aspect 15 can include, or can optionally be combined with the subject matter of one or any combination of Aspects 8 to 14 to optionally include the connection apparatus is coupled with a coaxial cable system; wherein the coaxial cable system is a component of an aerospace, aviation, automotive or aquatic device.

Aspect 16 can include subject matter such as A method of retaining a threaded connection between two threaded components of an electrical system, the method including: inserting a threaded hub into a threaded housing, the threaded housing including an opening defined by a threaded housing wall; wherein the threaded housing includes a first engagement recess and a second engagement recess, each engagement recess extending through the threaded housing wall; rotating the threaded hub into the threaded housing; wherein one or more of the first engagement recess or the second engagement recess is positioned relative to the threaded hub; coupling a vise anchor, including a first jaw and a second jaw, with the threaded housing, coupling includes: aligning the first jaw with one engagement recess and aligning the second jaw with another engagement recess; and inserting the first jaw through the first engagement recess and the second jaw through the second engagement recess; receiving the first jaw and the second jaw in a trough of the threaded hub; and clasping the threaded hub between the first jaw and the second jaw.

Aspect 17 can include, or can optionally be combined with the subject matter of one or any combination of Aspect 16 to optionally include the threaded housing is one of a male connector or female connector of the electrical system.

Aspect 18 can include, or can optionally be combined with the subject matter of one or any combination of Aspects 16 or 17 to optionally include each of the first jaw and the second jaw includes a lobe, the method including: inserting the lobe through one of the first engagement recess and the second engagement recess; and statically retaining the threaded hub relative to the threaded housing.

Aspect 19 can include, or can optionally be combined with the subject matter of one or any combination of Aspects 16 to 18 to optionally include providing an additional grounding path with the vise anchor.

Aspect 20 can include, or can optionally be combined with the subject matter of one or any combination of Aspects 16 to 19 to optionally include the vise anchor is a clip.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A retention system for an electrical connection, the retention system comprising:
a threaded housing having a housing wall, the threaded housing including:
an opening, defined by the housing wall, at a first end of the threaded housing; and
one or more engagement recesses extending through a portion of the housing wall;
a threaded hub including a plurality of teeth and a trough between each tooth of the plurality of teeth; and
a vise anchor including:
two or more jaws interconnected by a bridge, each jaw including an engagement portion at an end portion;
wherein the engagement portion is configured to extend through the one or more engagement recesses;
wherein the engagement portion is configured to be received within the trough;
wherein in a rotation configuration, the threaded hub is configured to be rotatably received within the threaded housing;
wherein in an anchored configuration, the vise anchor is statically coupled with the threaded housing and each jaw is configured to maintain retention of the threaded hub received within the threaded housing.

2. The retention system of claim 1, wherein the housing wall includes an internal threaded surface configured to mate with the threaded hub.

3. The retention system of claim 1, including:
a junction portion on a second side of the threaded housing from the opening;
wherein the threaded housing is coupled with an electrical cable at the junction portion.

4. The retention system of claim 1, wherein the threaded hub is a threaded shaft including a complementary thread with the threaded housing.

5. The retention system of claim 1, wherein the bridge includes an arcuate profile complementary to perimeter surface of the threaded housing.

6. The retention system of claim 1, wherein the retention system is a grounding path.

7. The retention system of claim 1, wherein the vise anchor is a clip.

8. A connection apparatus for a threaded electrical coupling, the connection apparatus comprising:
a threaded housing having a first end portion and a second end portion, the threaded housing including:
a wall defining an opening at the first end portion;
wherein the opening is configured to receive a threaded coupling;
one or more engagement recesses extending through the wall proximate to the first end portion; and
a junction portion at the second end portion, the junction portion coupled with an electrical cable; and
a vise anchor including:
two or more jaws, each jaw including an engagement portion at a distal portion,
wherein the engagement portion includes a profile configured to be positioned within the one or more engagement recesses.

9. The connection apparatus of claim 8, wherein the wall includes a threaded interior surface.

10. The connection apparatus of claim 8, wherein each engagement portion includes a lobe, the lobe configured to extend through one of the one or more engagement recesses.

11. The connection apparatus of claim 8, wherein the vise anchor includes an arcuate bridge extending between each jaw;
wherein the arcuate bridge is configured to extend around an perimeter surface of the wall.

12. The connection apparatus of claim 8, wherein the threaded housing is configured to mate with an opposing threaded electrical shaft.

13. The connection apparatus of claim 12, wherein the engagement portion is configured to fit within a trough of the threaded electrical shaft;
wherein in an anchored configuration, the vise anchor is statically coupled with the threaded housing and each jaw is configured to maintain retention of the threaded electrical shaft received within the threaded housing.

14. The connection apparatus of claim 8, wherein the threaded housing is a radio frequency (RF) connector.

15. The connection apparatus of claim 8, wherein the connection apparatus is coupled with a coaxial cable system;
wherein the coaxial cable system is a component of an aerospace, aviation, automotive or aquatic device.

16. A method of retaining a threaded connection between two threaded components of an electrical system, the method including:
inserting a threaded hub into a threaded housing, the threaded housing including an opening defined by a threaded housing wall;
wherein the threaded housing includes a first engagement recess and a second engagement recess, each engagement recess extending through the threaded housing wall;
rotating the threaded hub into the threaded housing;
wherein one or more of the first engagement recess or the second engagement recess is positioned relative to the threaded hub;
coupling a vise anchor, including a first jaw and a second jaw, with the threaded housing, coupling includes:
aligning the first jaw with one engagement recess and aligning the second jaw with another engagement recess; and
inserting the first jaw through the first engagement recess and the second jaw through the second engagement recess;
receiving the first jaw and the second jaw in a trough of the threaded hub; and
clasping the threaded hub between the first jaw and the second jaw.

17. The method of retaining the threaded connection of claim 16, wherein the threaded housing is one of a male connector or female connector of the electrical system.

18. The method of retaining the threaded connection of claim 16, wherein each of the first jaw and the second jaw includes a lobe, the method including:
inserting the lobe through one of the first engagement recess and the second engagement recess; and
statically retaining the threaded hub relative to the threaded housing.

19. The method of retaining the threaded connection of claim 16, including:
providing an additional grounding path with the vise anchor.

20. The method of retaining the threaded connection of claim 16, wherein the vise anchor is a clip.
